(19) United States
(12) Patent Application Publication
(10) Pub. No.: US 2026/0179117 A1
(43) Pub. Date: Jun. 25, 2026

(54) ADVERTISEMENT EFFECT ESTIMATION APPARATUS, ADVERTISEMENT EFFECT ESTIMATION METHOD, AND NON-TRANSITORY COMPUTER-READABLE MEDIUM

(71) Applicant: NEC Corporation, Tokyo (JP)

(72) Inventors: Rui KONDO, Tokyo (JP); Yoshitomo WARASHINA, Tokyo (JP)

(73) Assignee: NEC Corporation, Tokyo (JP)

(21) Appl. No.: 19/410,124

(22) Filed: Dec. 5, 2025

(30) Foreign Application Priority Data
Dec. 23, 2024 (JP) 2024-226594

(51) Int. Cl. G06Q 30/0242

(52) U.S. Cl. CPC G06Q 30/0242

(57) ABSTRACT

An advertisement effect estimation apparatus includes a range information acquisition unit, a user information acquisition unit, a first estimation unit, and a second estimation unit. The range information acquisition unit acquires range information indicating an effect range set as a range in which an effect of a target advertisement being present in a virtual space occurs. The user information acquisition unit acquires history information indicating at least a part of a movement history of an avatar within the effect range. The first estimation unit generates first estimation information indicating an estimation result of a magnitude of an interest held in the target advertisement by the user associated to the avatar by using the history information. The second estimation unit generates second estimation information indicating an estimation result of value generated by the target advertisement for the user by using the first estimation information.

This application is based upon and claims the benefit of priority from Japanese patent application No. 2024-226594, filed on Dec. 23, 2024, the disclosure of which is incorporated herein its entirety by reference.

### TECHNICAL FIELD

The present invention relates to an advertisement effect estimation apparatus, an advertisement effect estimation method, and a non-transitory computer-readable medium storing a program thereof.

### BACKGROUND ART

In recent years, use of virtual spaces has been advancing. There are cases where advertisements are displayed in virtual spaces. JP 2024-145035 A describes a technique for detecting that a user has viewed the advertisement. Specifically, the information processing system described in JP 2024-145035 A determines that the user has viewed the advertisement object in a case where the avatar of the user has stayed in the collision range set around the advertisement object for a predetermined time or more.

### SUMMARY

In many cases, the effect of the advertisement cannot be accurately determined only by detecting whether the user has viewed the advertisement. An example of an object of the present invention is to accurately estimate an effect of an advertisement displayed in a virtual space.

An advertisement effect estimation apparatus according to one aspect of the present disclosure includes
at least one memory storing instructions; and
at least one processor configured to execute the instructions to perform operations comprising
acquiring range information indicating an effect range set as a range in which an effect of a target advertisement being present in a virtual space occurs,
acquiring history information indicating at least a part of a movement history of an avatar within the effect range,
generating first estimation information indicating an estimation result of a magnitude of an interest held in the target advertisement by the user associated to the avatar by using the history information, and
generating second estimation information indicating an estimation result of value generated by the target advertisement for the user by using the first estimation information.

An advertisement effect estimation method according to one aspect of the present disclosure includes,
by a computer,
acquiring range information indicating an effect range set as a range in which an effect of a target advertisement being present in a virtual space occurs,
acquiring history information indicating at least a part of a movement history of an avatar within the effect range,
generating first estimation information indicating an estimation result of a magnitude of an interest held in the target advertisement by the user associated to the avatar by using the history information, and
generating second estimation information indicating an estimation result of value generated by the target advertisement for the user by using the first estimation information.

A non-transitory computer-readable medium according to one aspect of the present disclosure stores a program for causing a computer to perform operations comprising:
acquiring range information indicating an effect range set as a range in which an effect of a target advertisement being present in a virtual space occurs,
acquiring history information indicating at least a part of a movement history of an avatar within the effect range,
generating first estimation information indicating an estimation result of a magnitude of an interest held in the target advertisement by the user associated to the avatar by using the history information, and
generating second estimation information indicating an estimation result of value generated by the target advertisement for the user by using the first estimation information.

According to an example of the present disclosure, it is possible to accurately estimate an effect of an advertisement displayed in a virtual space.

### BRIEF DESCRIPTION OF THE DRAWINGS

FIG. 1 It is a diagram illustrating an example of a use environment of an advertisement effect estimation apparatus;

FIG. 2 It is a diagram illustrating an example of a use environment of an advertisement effect estimation apparatus;

FIG. 3 It is a diagram illustrating an example of a functional configuration of an advertisement effect estimation apparatus;

FIG. 4 It is a diagram for explaining an example of processing performed by a first estimation unit;

FIG. 5 It is a diagram for explaining an example of processing performed by a first estimation unit;

FIG. 6 It is a diagram for explaining an example of processing performed by a first estimation unit;

FIG. 7 It is a diagram for explaining an example of processing performed by a first estimation unit;

FIG. 8 It is a diagram for explaining an example of processing performed by a second estimation unit;

FIG. 9 It is a diagram illustrating an example of a screen displayed on a display of a communication apparatus;

FIG. 10 It is a diagram illustrating an example of a screen displayed on a display of a communication apparatus;

FIG. 11 It is a diagram illustrating a hardware configuration example of an advertisement effect estimation apparatus; and

FIG. 12 It is a flowchart illustrating an example of processing performed by an advertisement effect estimation apparatus.

### EXAMPLE EMBODIMENT

Hereinafter, in the present disclosure, the drawings are associated with one or more example embodiments. In all the drawings, similar components are denoted by similar reference signs, and descriptions thereof will not be repeated as appropriate.

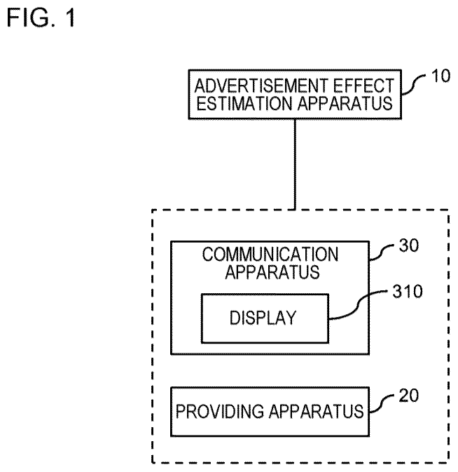

An advertisement effect estimation apparatus 10 is used together with a providing apparatus 20 and a communication apparatus 30 as illustrated in FIG. 1, for example. The providing apparatus 20 is an apparatus for providing a service using a virtual space to a user. The communication apparatus 30 is an apparatus operated by a user and includes a display 310. The communication apparatus 30 is, for example, a smartphone, a tablet terminal, a desktop personal computer, or a notebook personal computer. The communication apparatus 30 may include a head-mounted display type device as the display 310.

The avatar of the user is present in the virtual space provided by the providing apparatus 20. The providing apparatus 20 generates a screen to be shown to the user using at least the position of the avatar in the virtual space. This screen is associated to a scene of the virtual space obtained with reference to the current position of the avatar, for example, a scene of the virtual space as viewed from the avatar, and is displayed on the display 310 of the communication apparatus 30. In generating this screen, the providing apparatus 20 may further use at least one of the orientation of the avatar's body or face and the line of sight. Hereinafter, the orientation of the body or face of the avatar is referred to as the orientation of the avatar. At least a part of this processing may be performed by the communication apparatus 30.

The user performs an input for changing the position of the avatar by operating the communication apparatus 30. Then, the providing apparatus 20 changes the position of the avatar in accordance with the input, and changes the screen to be displayed on the display 310 in accordance with the change in the position. At least a part of this processing may be performed by the communication apparatus 30.

An advertisement may be displayed in the virtual space provided by the providing apparatus 20. This advertisement is displayed, for example, at a specific position in the virtual space. However, the advertisement may be moving. For example, the advertisement may be a non-player character. Then, the advertisement effect estimation apparatus 10 performs processing for estimating what value the advertisement has generated by displaying the advertisement to the user.

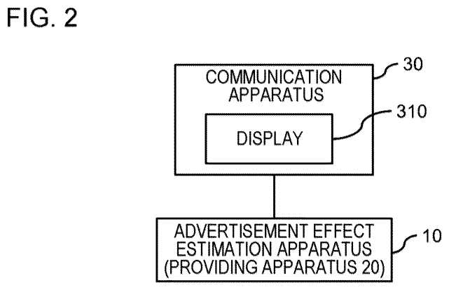

As illustrated in FIG. 2, the advertisement effect estimation apparatus 10 may also serve as the providing apparatus 20.

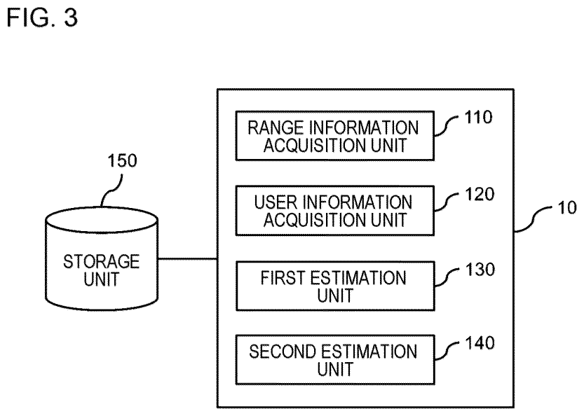

As illustrated in FIG. 3, for example, the advertisement effect estimation apparatus 10 includes a range information acquisition unit 110, a user information acquisition unit 120, a first estimation unit 130, and a second estimation unit 140, and can use information stored in the storage unit 150. The storage unit 150 may be a part of the advertisement effect estimation apparatus 10, a part of the providing apparatus 20, or an apparatus different from these.

The range information acquisition unit 110 acquires range information indicating an effect range. The effect range is set as a range in which the effect of the target advertisement being present in the virtual space occurs. The range information is stored in the storage unit 150, for example.

The user information acquisition unit 120 acquires history information indicating at least a part of the movement history of the avatar within the effect range. The movement history of the avatar is stored in, for example, the storage unit 150.

The first estimation unit 130 generates the first estimation information by using the history information acquired by the user information acquisition unit 120. The first estimation information indicates an estimation result of the magnitude of the interest held in the target advertisement by the user associated to the avatar.

The second estimation unit 140 generates the second estimation information by using the first estimation information generated by the first estimation unit 130. The second estimation information indicates an estimation result of the value generated by the target advertisement for the user.

As described above, the advertisement effect estimation apparatus 10 uses the first estimation information in a case of generating the second estimation information indicating the estimation result of the value generated by the target advertisement for the user. The first estimation information indicates an estimation result of the magnitude of the interest held in the target advertisement by the user associated to the avatar. Therefore, the advertisement effect estimation apparatus 10 can accurately estimate the effect of the target advertisement displayed in the virtual space.

Hereinafter, an example of a function of the advertisement effect estimation apparatus 10 will be described in detail.

The range information acquisition unit 110 acquires the range information as described above. The range information includes, for example, information for determining the position of the effect range with reference to the front of the advertisement, and information indicating the shape and size of the effect range. An example of the former information is to superimpose the front of the advertisement on the edge of the effect range. An example of the latter information is information indicating the shape of the effect range and information indicating how many times a specific portion of the shape (for example, one side of a rectangle) is to be made with respect to a width of a front surface of the advertisement. In this way, for example, as the advertisement displayed in the virtual space becomes larger, the effect range can be increased. However, in the latter information, the size of the effect range may be fixed.

The range information may be one or plural. In the former case, one piece of range information is applied to all advertisements. In the latter case, for example, the range information may be set for each of a plurality of advertisements, or may be set for each attribute of the advertisement. The range information is stored in the storage unit 150, for example. In this case, the range information acquisition unit 110 acquires the range information associated to the target advertisement from the storage unit 150.

The attribute of the advertisement is, for example, at least one of the following:
Presence or absence of characters. For example, in a case where there are characters, the effect range is narrowed.
In a case where there are characters, their sizes. For example, in a case where the characters are large, the effect range is increased.
Two-dimensional or three-dimensional. For example, in the case of being three-dimensional, the effect range is widened as compared with the case of being two-dimensional.
Whether there is movement. For example, in a case where there is movement, the effect range is increased.
Presence or absence of sound. For example, whether a sound is played in a case where the avatar approaches the advertisement. In a case where there is a sound, a range in which the sound is played is set as an effect range.

The providing apparatus 20 may be able to provide a plurality of virtual spaces. There may be a plurality of providing apparatuses 20, and these plurality of providing apparatuses 20 may provide mutually different virtual spaces. In these cases, the image quality, for example, the resolution or the frame rate of the image displayed on the display 310 may vary depending on the virtual space. Therefore, the range information may be determined for each virtual space. For example, an effect range associated to a virtual space in which image quality is high is relatively wide. In this case, the first estimation unit 130 acquires range information associated to the virtual space in which the avatar is present, that is, the virtual space provided to the communication apparatus 30.

The user information acquisition unit 120 acquires history information. The history information indicates at least a part, preferably all, of the movement history of the avatar within the effect range. The movement history includes, for example, information capable of specifying the path of the avatar and the stay time at each point on the path. The movement history indicates, for example, the position of the avatar at predetermined time intervals (for example, every second). Then, the history information includes, for example, information capable of specifying a path from a time at which the avatar enters the effect range of the target advertisement until a time at which the avatar exits, and a stay time and a moving speed at each point on the path. The movement history may further include information indicating at least one of the direction of the avatar and the line of sight at each point on the path. Hereinafter, this information is referred to as line-of-sight information.

The history information may further include at least one of a movement history of the avatar immediately before entering the effect range and a movement history of the avatar immediately after leaving the effect range. Here, the time immediately before and immediately after is, for example, 10 seconds or more and 1 minute or less, but is not limited to this range. The movement history is stored in the storage unit 150, for example. Then, the user information acquisition unit 120 acquires history information from the storage unit 150, for example.

The first estimation unit 130 generates the first estimation information by using the history information acquired by the user information acquisition unit 120. The first estimation information indicates an estimation result of the magnitude of the interest held in the target advertisement by the user associated to the avatar. This estimation result is indicated by, for example, a numerical value. In this case, for example, as the interest held by the user in the target advertisement increases, this numerical value increases.

For example, the first estimation unit 130 obtains the minimum value of the distance between the avatar and the target advertisement using the path information. Then, as the minimum value decreases, it is estimated that the interest of the user is high. In a case where the history information includes the line-of-sight information, the first estimation unit 130 may estimate that the interest of the user increases as the angle formed by the direction or the line-of-sight of the avatar and the line perpendicular to the front of the target advertisement decreases.

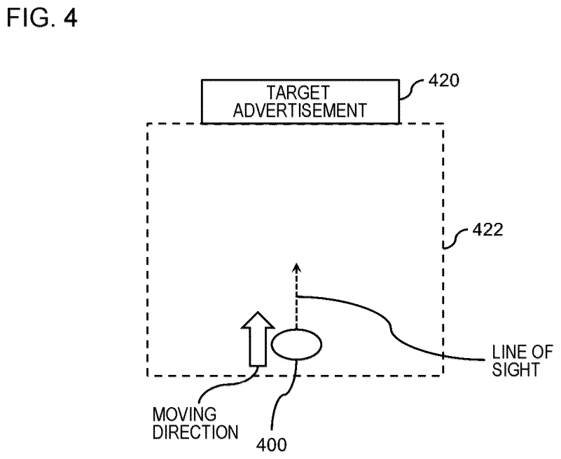

As illustrated in FIG. 4, in a case where the avatar 400 enters the effect range 422 in a direction toward the target advertisement 420, the first estimation unit 130 estimates that the user's interest in the target advertisement 420 is high. Here, the first estimation unit 130 may estimate the magnitude of the interest of the user using an angle formed by a line perpendicular to the front of the target advertisement 420 and the approach direction of the avatar 400. For example, in a case where this angle is small, the first estimation unit 130 estimates that the user's interest is high. In the effect range 422, the first estimation unit 130 estimates that the user's interest is high in both a case where the avatar 400 moves toward a position in front of the target advertisement 420 and a case where the avatar moves in a direction approaching the effect range 422. The first estimation unit 130 may estimate that the interest of the user increases as the angle formed by the direction or the line of sight of the avatar and the line perpendicular to the front of the target advertisement decreases during the movement.

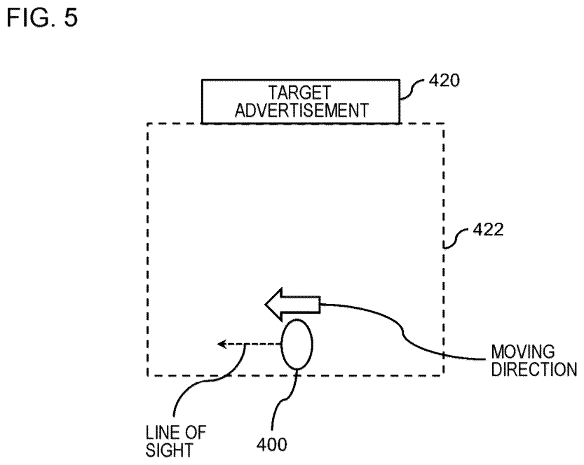

For example, as illustrated in FIG. 5, in a case where the avatar 400 moves in a direction away from the front of the target advertisement 420, the first estimation unit 130 estimates that the interest of the user is low. The first estimation unit 130 may estimate that the interest of the user is lower as the angle formed by the direction or the line of sight of the avatar and the line perpendicular to the front of the target advertisement increases while the movement is performed.

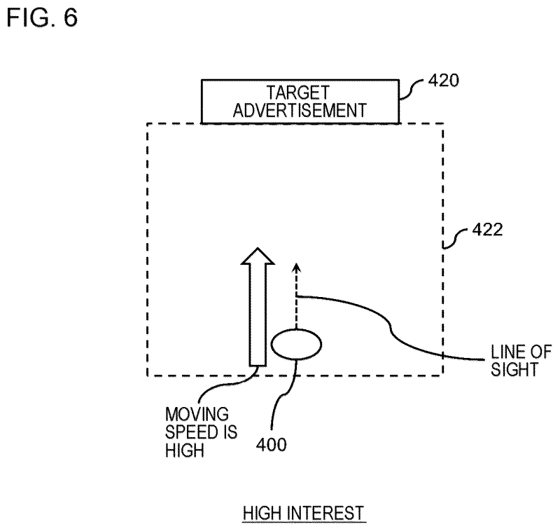

For example, as illustrated in FIG. 6, the first estimation unit 130 may generate the first estimation information using at least one of the moving speed at a time at which the avatar 400 enters the effect range 422 and the moving speed of the avatar 400 within the effect range 422. For example, the first estimation unit 130 estimates that the user's interest increases as the moving speed at a time at which the avatar 400 enters the effect range 422 increases. In a case where the avatar 400 is within the effect range 422 and further moves in a direction approaching the target advertisement 420, the first estimation unit 130 may estimate that the interest of the user increases as the moving speed at that time increases.

For example, the first estimation unit 130 may generate, as the first estimation information, information indicating the magnitude of interest of the user at a specific point in the movement history of the avatar indicated by the history information. In this example, an example of the specific point is a point where the avatar comes closest to the target advertisement or a point where the avatar enters the effect range. In a case where the history information indicates the position of the avatar at predetermined time intervals (for example, every second), the first estimation unit 130 may calculate a value indicating the magnitude of interest of the user in the target advertisement at each of the plurality of positions, and may use a history of this value as the first estimation information.

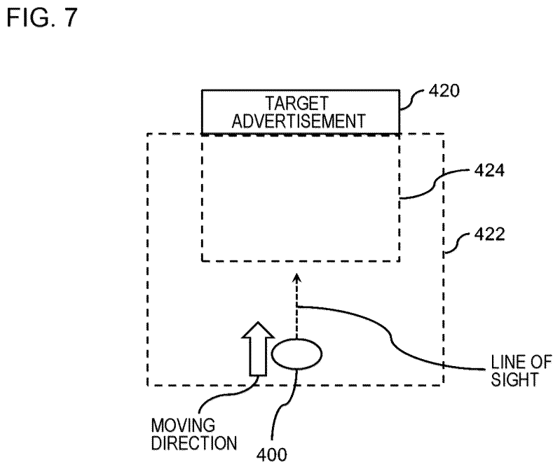

For example, as illustrated in FIG. 7, a plurality of effect ranges may be set. In the plurality of effect ranges, magnitudes of the effects generated by the advertisement are different from each other. For example, the closer to an advertisement, the greater the effect of the advertisement in the effect range. For example, in the example illustrated in FIG. 7, the effect range 422 and a second effect range 424 are located. The second effect range 424 is an area adjacent to the target advertisement 420, and the effect range 422 is an area surrounding the second effect range 424. The effect generated by the advertisement in the second effect range 424 is greater than the effect generated by the advertisement in the effect range 422. Then, in each of the plurality of effect ranges, effect information capable of specifying the magnitude of the effect of the advertisement in a case where the avatar is present in the effect range is associated. In this case, the range information includes a plurality of effect ranges and effect information associated to the effect ranges.

In this case, the first estimation unit 130 generates the first estimation information by using the movement history for each of the plurality of effect ranges and the effect information for each of the plurality of effect ranges. Specifically, the first estimation unit 130 generates information, for example, a value indicating the estimation result of the magnitude of the interest held by the user in the target advertisement using the movement history and the effect information for each of the plurality of effect ranges. This processing is as described with reference to FIGS. 4 to 7, for example. Then, the first estimation unit 130 generates the first estimation information by processing the information for each of the plurality of effect ranges. The processing performed here is, for example, averaging and addition, but may be other processing.

The second estimation unit 140 generates the second estimation information by using the first estimation information. The second estimation information indicates an estimation result of the value generated by the target advertisement for the user. In a case where the first estimation information is a value indicating the magnitude of the interest of the user at the specific point, the second estimation unit 140 may use this value as the second estimation information.

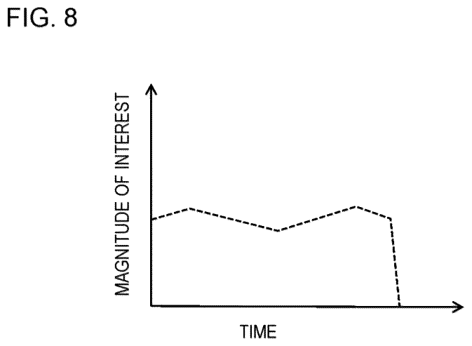

In a case where the first estimation information includes a value indicating the magnitude of the interest of the user in the target advertisement at each of the plurality of positions indicating the movement path of the avatar in the effect range, that is, in a case where the first estimation information indicates the temporal transition of this value as illustrated in FIG. 8, the second estimation unit 140 may generate the second estimation information by statistically processing the plurality of values. This statistical processing is, for example, integration or calculation of an average value, but may be other processing.

For each advertisement, an attribute of a person targeted by the advertisement may be defined. This attribute is, for example, at least one of age group and sex. Then, in a case where the attribute of the user associated to the avatar matches the attribute that is the target of the target advertisement, the second estimation unit 140 may increase the value indicated by the second estimation information. For example, the second estimation unit 140 acquires the attribute targeted by the target advertisement and the attribute of the user from the providing apparatus 20.

The second estimation unit 140 may further generate the second estimation information by using the length of time during which the avatar stayed in the effect range. For example, in a case where the first estimation information is a value indicating the magnitude of the interest of the user at the specific point, the second estimation unit 140 may generate the second estimation information by multiplying this value by a coefficient proportional to the length of the stay time. The second estimation unit 140 may generate the second estimation information by multiplying the average value of the first estimation information described above by a coefficient proportional to the length of the stay time.

Here, the second estimation unit 140 may generate the second estimation information by using a comparison result between the length of the stay time described above and the reference value. This reference value is stored in the storage unit 150, for example. For example, the second estimation unit 140 may generate the second estimation information by calculating a ratio of the length of the stay time to the reference value and multiplying the average value of the first estimation information described above by the ratio. The reference value used here is, for example, a statistically calculated value. As an example, the reference value is set in a case where a plurality of avatars stays in the effect range of the target advertisement. It is an average value of the lengths of the stay times of the plurality of avatars.

The reference value described above may be determined for each attribute of the person. The attribute here is, for example, at least one of age group and sex. In this case, the second estimation unit 140 reads the reference value associated to the attribute of the user from the storage unit 150 and uses the read reference value. The reference value for each attribute is determined, for example, by performing the above-described average value calculation processing for each attribute of the user associated to the avatar.

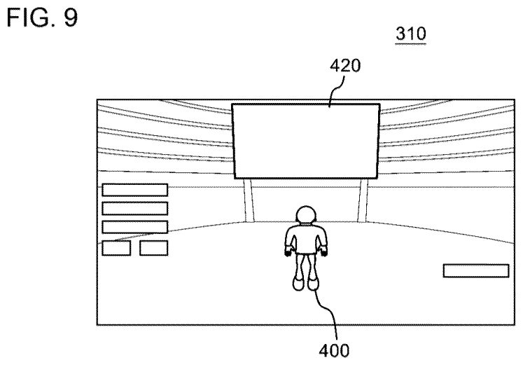

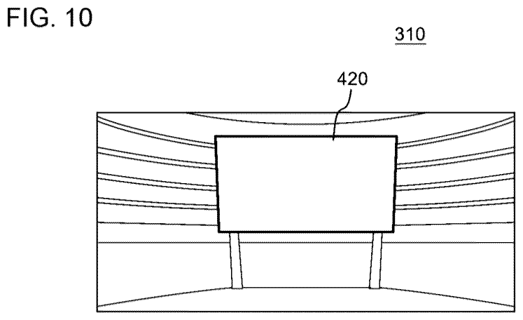

As described above, the screen to be shown to the user is displayed on the display 310. As illustrated in FIG. 9, for example, the screen may be displayed in a case where the virtual space is viewed from the viewpoint of the third party. In this case, the first estimation unit 130 may generate the first estimation information by further using the display mode of the target advertisement on this screen, and the second estimation unit 140 may generate the second estimation information by further using the display mode of the target advertisement on this screen, or both of them may be performed. This processing may be further performed in a case where a screen illustrated in FIG. 10 to be described later is displayed.

The display mode here is, for example, the direction in which the advertisement is displayed, the size of the advertisement, and the display position of the advertisement.

An example of the information indicating the direction in which the advertisement is displayed is information indicating the direction in which the advertisement is directed on the screen displayed on the display 310 in the virtual space. For example, the first estimation unit 130 increases the value as the first estimation information as the direction of the advertisement approaches the front. In a case of generating the second estimation information by multiplying the value indicated by the first estimation information by a predetermined coefficient, the second estimation unit 140 increases the coefficient described above as the direction of the advertisement approaches the front.

The first estimation unit 130 increases the value as the first estimation information as the advertisement displayed on the screen displayed on the display 310 increases, that is, as the proportion occupied by the advertisement on the screen increases. In a case of generating the second estimation information by multiplying the value indicated by the first estimation information by a predetermined coefficient, the second estimation unit 140 increases the coefficient described above as this angle increases.

In a case where an advertisement is displayed at the center of the display 310, the first estimation unit 130 may increase the value as the first estimation information, or the second estimation unit 140 may increase the above-described coefficient, as compared with a case where an advertisement is displayed at the end of the display 310.

As illustrated in FIG. 10, a screen in a state where the virtual space is viewed from the viewpoint of the avatar may be displayed on the display 310. In this example, in a case where the history information includes the line-of-sight information indicating the direction of the line of sight of the avatar, the first estimation unit 130 may generate the first estimation information by further using the line-of-sight information, or the second estimation unit 140 may generate the second estimation information by further using the line-of-sight information, or both of them may be performed. This processing may be further performed in a case where the screen illustrated in FIG. 9 is displayed.

An example of the processing in which the first estimation unit 130 uses the line-of-sight information is as described with reference to FIG. 3. An example of processing in which the second estimation unit 140 uses the line-of-sight information is to determine the coefficient by using the line-of-sight information in a case where the second estimation information is generated by multiplying the value indicated by the first estimation information by a predetermined coefficient. For example, the second estimation unit 140 calculates an average value of the angle formed by the direction or the line of sight of the avatar and the line perpendicular to the front of the target advertisement while the avatar is located in the effect range, and increases the coefficient as the average value decreases.

In the virtual space, the user may make an utterance via the avatar. An example of this utterance is a conversation with another avatar. The providing apparatus 20 stores information indicating the amount and content of the utterance. Then, the advertisement effect estimation apparatus 10 may further acquire and use this information from the providing apparatus 20.

For example, the user information acquisition unit 120 acquires the utterance information from the providing apparatus 20. The utterance information indicates at least one of the amount and the content of the utterance made by the avatar while the avatar is located in the effect range of the target advertisement. Then, the first estimation unit 130 may generate the first estimation information by further using the utterance information, and the second estimation unit 140 may generate the second estimation information by further using the utterance information, or both of them may be performed.

For example, the first estimation unit 130 increases the value as the first estimation information as the amount of utterance, for example, the number of characters or the utterance time increases. In a case where the second estimation information is generated by multiplying the value indicated by the first estimation information by a predetermined coefficient, the second estimation unit 140 increases the coefficient described above as the amount of utterance, for example, the number of characters or the utterance time increases.

The first estimation unit 130 increases the value as the first estimation information as the number of keywords included in the utterance increases. In a case of generating the second estimation information by multiplying the value indicated by the first estimation information by a predetermined coefficient, the second estimation unit 140 increases the coefficient described above as the number of keywords described above increases. The keywords are stored in the storage unit 150 in association with each advertisement, for example, for each advertisement. Then, the first estimation unit 130 and the second estimation unit 140 acquire the keywords associated to the target advertisement from the storage unit 150.

For example, in a case where the user is wearing a wearable device such as a smart watch, there is a case where vital information of the user while the user is operating the avatar can be acquired. Here, the vital information is, for example, at least one of a heart rate, a maximum blood pressure, and a perspiration amount, but may be other information. The user information acquisition unit 120 may further acquire the vital information from, for example, a wearable device or the communication apparatus 30. Then, the first estimation unit 130 may generate the first estimation information by further using the vital information, or the second estimation unit 140 may generate the second estimation information by further using the vital information, or both of them may be performed.

For example, the first estimation unit 130 increases the value as the first estimation information as at least one of the heart rate, the maximum blood pressure, and the perspiration amount increases. In a case where the second estimation information is generated by multiplying the value indicated by the first estimation information by a predetermined coefficient, the second estimation unit 140 increases the coefficient described above as at least one of the heart rate, the maximum blood pressure, and the perspiration amount increases.

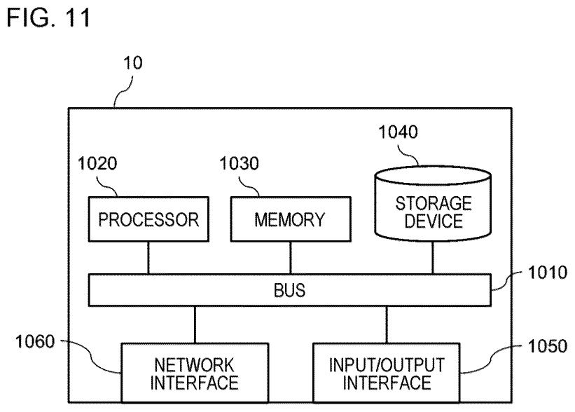

As illustrated in FIG. 11, for example, the advertisement effect estimation apparatus 10 includes a bus 1010, a processor 1020, a memory 1030, a storage device 1040, an input/output interface 1050, and a network interface 1060 as a hardware configuration.

The bus 1010 is a data transmission path for the processor 1020, the memory 1030, the storage device 1040, the input/output interface 1050, and the network interface 1060 to transmit and receive data to and from each other. However, the method for connecting the processor 1020 and other components to each other is not limited to the bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus implemented by a removable medium such as a hard disk drive (HDD), a solid state drive (SSD), a memory card, or a flash read only memory (FROM), and has a recording medium. A recording medium of the storage device 1040 stores a program module that implements each function (for example, the range information acquisition unit 110, the user information acquisition unit 120, the first estimation unit 130, and the second estimation unit 140) of the advertisement effect estimation apparatus 10. The processor 1020 implements the functions associated to the program modules by reading and executing the program modules on the memory 1030. The storage device 1040 may further function as the storage unit 150.

The input/output interface 1050 is an interface for connecting the advertisement effect estimation apparatus 10 and various pieces of input/output equipment. For example, the advertisement effect estimation apparatus 10 may communicate with the storage unit 150 via the input/output interface 1050.

The network interface 1060 is an interface for connecting the advertisement effect estimation apparatus 10 to a network. The network is, for example, a local area network (LAN) or a wide area network (WAN). A method for connecting the network interface 1060 to the network may be a wireless connection or a wired connection. The advertisement effect estimation apparatus 10 may communicate with the providing apparatus 20, the communication apparatus 30, and the storage unit 150 via the network interface 1060.

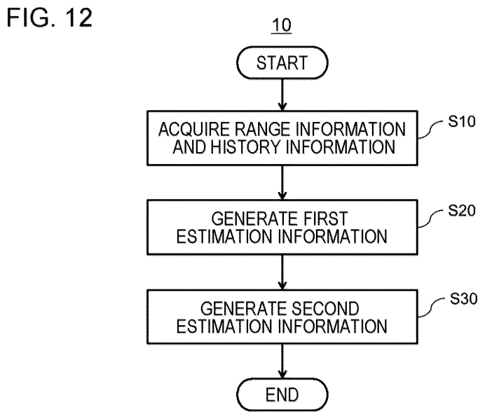

The advertisement effect estimation apparatus 10 performs processing according to, for example, the flowchart illustrated in FIG. 12. This processing is repeatedly performed, for example, in a batch format.

First, the range information acquisition unit 110 specifies the user and acquires the movement history of the avatar associated to the user from, for example, the storage unit 150. Then, by processing the movement history, the range information acquisition unit 110 specifies whether the avatar has entered the effect range of any advertisement by using the range information of each advertisement. The range information acquisition unit 110 also acquires the range information from the storage unit 150. Then, in a case where the advertisement is within the effect range of any advertisement, the range information acquisition unit 110 specifies the advertisement, that is, the range information of the target advertisement, and the user information acquisition unit 120 extracts history information associated to the target advertisement from the movement history (step S10).

Then, the first estimation unit 130 generates a first estimation information (step S20). Furthermore, the second estimation unit 140 generates second estimation information (step S30). Thereafter, the second estimation unit 140 stores the second estimation information in the storage unit 150 in association with the target advertisement.

The above-described processing is performed for each of a plurality of users. In a case where one user is within the effect range of each of a plurality of advertisements, the processing illustrated in FIG. 12 is performed on each of the plurality of advertisements.

Then, the second estimation unit 140 statistically processes the second estimation information for each of the plurality of advertisements for each predetermined period, thereby generating information indicating the value generated by the advertisement, that is, information indicating the effect of the advertisement for each predetermined period and for each advertisement. The predetermined period is, for example, one day or more and one month or less, but is not limited to this range. An example of the statistical processing is addition, for example.

As described above, the advertisement effect estimation apparatus 10 calculates the first estimation information, and then generates the second estimation information indicating the estimation result of the value generated by the target advertisement for the user by using the first estimation information. The first estimation information indicates an estimation result of the magnitude of the interest held in the target advertisement by the user associated to the avatar. Therefore, the advertisement effect estimation apparatus 10 can accurately estimate the effect of the target advertisement displayed in the virtual space.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

In the plurality of flowcharts used in the above description, a plurality of steps (pieces of processing) is described in order, but the execution order of the steps executed in each example embodiment is not limited to the described order. In each example embodiment, the order of the illustrated steps can be changed as long as nothing interferes in terms of content.

Some or all of the example embodiments described above may be described as the following Supplementary Notes, but are not limited to the following.
1. An advertisement effect estimation apparatus including:
   a range information acquisition means for acquiring range information indicating an effect range set as a range in which an effect of a target advertisement being present in a virtual space occurs;
   a user information acquisition means for acquiring history information indicating at least a part of a movement history of an avatar within the effect range;
   a first estimation means for generating first estimation information indicating an estimation result of a magnitude of an interest held in the target advertisement by the user associated to the avatar by using the history information; and
   a second estimation means for generating second estimation information indicating an estimation result of value generated by the target advertisement for the user by using the first estimation information.
2. The advertisement effect estimation apparatus according to the above 1, wherein
   the second estimation means generates the second estimation information by further using a length of time during which the avatar stays in the effect range.
3. The advertisement effect estimation apparatus according to the above 1 or 2, wherein
   the user information acquisition means further acquires vital information about the user, and
   at least one of a process in which the first estimation means generates the first estimation information by further using the vital information, and the second estimation means generates the second estimation information by further using the vital information, is performed.
4. The advertisement effect estimation apparatus according to any one of the above 1 to 3, wherein
   a screen in a state where the virtual space is viewed from a viewpoint of the avatar is displayed on a display viewed by the user,
   the history information includes line-of-sight information indicating a direction of a line of sight of the avatar, and
   at least one of a process in which the first estimation means generates the first estimation information by further using the line-of-sight information, and the second estimation means generates the second estimation information by further using the line-of-sight information, is performed.
5. The advertisement effect estimation apparatus according to any one of the above 1 to 3, wherein
   a screen in a state where the virtual space is viewed from a viewpoint of a third party is displayed on a display viewed by the user, and
   at least one of a process in which the first estimation means generates the first estimation information by further using a display mode of the target advertisement on the screen, and the second estimation means generates the second estimation information by further using the display mode of the target advertisement on the screen, is performed.
6. The advertisement effect estimation apparatus according to any one of the above 1 to 5, wherein
   the user information acquisition means acquires utterance information indicating at least one of an amount and a content of an utterance made by the avatar while the avatar is located in the effect range, and
   at least one of a process in which the first estimation means generates the first estimation information by further using the utterance information, and the second estimation means generates the second estimation information by further using the utterance information, is performed.
7. The advertisement effect estimation apparatus according to any one of the above 1 to 6, wherein
   the virtual space includes a plurality of virtual spaces,
   the range information is determined for each of the virtual spaces, and
   the range information acquisition means acquires the range information associated to the virtual space in which the avatar is present.
8. The advertisement effect estimation apparatus according to any one of the above 1 to 7, wherein
   the history information includes information capable of specifying a moving speed of the avatar, and
   the first estimation means generates the first estimation information by using at least one of a moving speed at a time at which the avatar enters the effect range and a moving speed of the avatar within the effect range.
9. The advertisement effect estimation apparatus according to the above 2, wherein
   the second estimation means generates the second estimation information by using a comparison result between a length of a stay time and a reference value.
10. The advertisement effect estimation apparatus according to the above 9, wherein
   the reference value is determined for each attribute of a person, and
   the second estimation means uses the reference value associated to the attribute of the user.
11. The advertisement effect estimation apparatus according to any one of the above 1 to 10, wherein
   the range information is determined for each of a plurality of advertisements or each attribute of an advertisement, and
   the range information acquisition means acquires the range information associated to the attribute of the target advertisement.
   12. The advertisement effect estimation apparatus according to any one of the above 1 to 11, wherein
   a plurality of the effect range having different magnitudes of the effect are set,
   the range information includes each of the plurality of effect ranges and effect information indicating a magnitude of the effect associated to each of the plurality of effect ranges, and

the first estimation means generates the first estimation information by using the movement history for each of the plurality of effect ranges and the effect information for each of the plurality of effect ranges.
13. An advertisement effect estimation method including,
   by a computer:
   acquiring range information indicating an effect range set as a range in which an effect of a target advertisement being present in a virtual space occurs;
   acquiring history information indicating at least a part of a movement history of an avatar within the effect range;
   generating first estimation information indicating an estimation result of a magnitude of an interest held in the target advertisement by the user associated to the avatar by using the history information; and
   generating second estimation information indicating an estimation result of value generated by the target advertisement for the user by using the first estimation information.
14. A program for causing
   a computer to implement:
   a range information acquisition means for acquiring range information indicating an effect range set as a range in which an effect of a target advertisement being present in a virtual space occurs;
   a user information acquisition means for acquiring history information indicating at least a part of a movement history of an avatar within the effect range;
   a first estimation means for generating first estimation information indicating an estimation result of a magnitude of an interest held in the target advertisement by the user associated to the avatar by using the history information; and
   a second estimation means for generating second estimation information indicating an estimation result of value generated by the target advertisement for the user by using the first estimation information.
15. A recording medium on which the program according to above 14 is recorded.

Some or all of the configurations described in Supplementary Notes 2 to 12 dependent on the above-described Supplementary Note 1 can also be dependent on each of Supplementary Notes 13 to 15 by similar dependency relationship to Supplementary Notes 2 to 12. Not only each of Supplementary Notes 1 and 13 to 15, but also various hardware, software, various recording means for recording software, or systems can be similarly dependent on some or all of the configurations described as the supplementary notes without departing from the above-described example embodiments.

1. An advertisement effect estimation apparatus comprising:
at least one memory storing instructions; and
at least one processor configured to execute the instructions to perform operations comprising:
acquiring range information indicating an effect range set as a range in which an effect of a target advertisement being present in a virtual space occurs;
acquiring history information indicating at least a part of a movement history of an avatar within the effect range;
generating first estimation information indicating an estimation result of a magnitude of an interest held in the target advertisement by the user associated to the avatar by using the history information; and
generating second estimation information indicating an estimation result of value generated by the target advertisement for the user by using the first estimation information.

2. The advertisement effect estimation apparatus according to claim 1, wherein
the operations comprise generating the second estimation information by using a length of time during which the avatar stays in the effect range.

3. The advertisement effect estimation apparatus according to claim 1, wherein the operations comprise:
acquiring vital information about the user; and
performing at least one of generating the first estimation information by further using the vital information, and generating the second estimation information by further using the vital information.

4. The advertisement effect estimation apparatus according to claim 1, wherein
a screen in a state where the virtual space is viewed from a viewpoint of the avatar is displayed on a display viewed by the user,
the history information includes line-of-sight information indicating a direction of a line of sight of the avatar, and
the operations comprise performing at least one of generating the first estimation information by further using the line-of-sight information, and generating the second estimation information by further using the line-of-sight information.

5. The advertisement effect estimation apparatus according to claim 1, wherein
a screen in a state where the virtual space is viewed from a viewpoint of a third party is displayed on a display viewed by the user, and
the operations comprise performing at least one of generating the first estimation information by further using a display mode of the target advertisement on the screen, and generating the second estimation information by further using the display mode of the target advertisement on the screen, is performed.

6. The advertisement effect estimation apparatus according to claim 1, wherein the operations comprise:
acquiring utterance information indicating at least one of an amount and a content of an utterance made by the avatar while the avatar is located in the effect range; and
performing at least one of generating the first estimation information by further using the utterance information, and generating the second estimation information by further using the utterance information, is performed.

7. The advertisement effect estimation apparatus according to claim 1, wherein
the history information includes information capable of specifying a moving speed of the avatar, and
the operations comprise generating the first estimation information by using at least one of a moving speed at a time at which the avatar enters the effect range and a moving speed of the avatar within the effect range.

8. The advertisement effect estimation apparatus according to claim 1, wherein
the range information is determined for each of a plurality of advertisements or each attribute of an advertisement, and
the operations comprise acquiring the range information associated to the attribute of the target advertisement.

9. The advertisement effect estimation apparatus according to claim 1, wherein
the virtual space includes a plurality of virtual spaces,
the range information is determined for each of the virtual spaces, and
the operations comprise acquiring the range information associated to the virtual space in which the avatar is present.

10. The advertisement effect estimation apparatus according to claim 2, wherein
the operations comprise generating the second estimation information by using a comparison result between a length of a stay time and a reference value.

11. The advertisement effect estimation apparatus according to claim 10, wherein
the reference value is determined for each attribute of a person, and
the operations comprise using the reference value associated to the attribute of the user.

12. The advertisement effect estimation apparatus according to claim 1, wherein
a plurality of the effect range having different magnitudes of the effect are set,
the range information includes each of the plurality of effect ranges and effect information indicating a magnitude of the effect associated to each of the plurality of effect ranges, and
the operations comprise generating the first estimation information by using the movement history for each of the plurality of effect ranges and the effect information for each of the plurality of effect ranges.

13. An advertisement effect estimation method comprising,
by a computer:
acquiring range information indicating an effect range set as a range in which an effect of a target advertisement being present in a virtual space occurs;
acquiring history information indicating at least a part of a movement history of an avatar within the effect range;
generating first estimation information indicating an estimation result of a magnitude of an interest held in the target advertisement by the user associated to the avatar by using the history information; and
generating second estimation information indicating an estimation result of value generated by the target advertisement for the user by using the first estimation information.

14. The advertisement effect estimation method according to claim 13, further comprising
generating the second estimation information by using a length of time during which the avatar stays in the effect range.

15. The advertisement effect estimation method according to claim 13, further comprising:
acquiring vital information about the user; and
performing at least one of generating the first estimation information by further using the vital information, and generating the second estimation information by further using the vital information.

16. The advertisement effect estimation method according to claim 13, wherein
a screen in a state where the virtual space is viewed from a viewpoint of the avatar is displayed on a display viewed by the user,
the history information includes line-of-sight information indicating a direction of a line of sight of the avatar, and
the advertisement effect estimation method comprises performing at least one of generating the first estimation information by further using the line-of-sight information, and generating the second estimation information by further using the line-of-sight information.

17. A non-transitory computer-readable medium storing a program for causing a computer to perform operations comprising:
acquiring range information indicating an effect range set as a range in which an effect of a target advertisement being present in a virtual space occurs;
acquiring history information indicating at least a part of a movement history of an avatar within the effect range;
generating first estimation information indicating an estimation result of a magnitude of an interest held in the target advertisement by the user associated to the avatar by using the history information; and
generating second estimation information indicating an estimation result of value generated by the target advertisement for the user by using the first estimation information.

18. The non-transitory computer-readable medium according to claim 17, wherein
the operations comprise generating the second estimation information by using a length of time during which the avatar stays in the effect range.

19. The non-transitory computer-readable medium according to claim 17, wherein the operations comprise:
acquiring vital information about the user; and
performing at least one of generating the first estimation information by further using the vital information, and generating the second estimation information by further using the vital information.

20. The non-transitory computer-readable medium according to claim 17, wherein
a screen in a state where the virtual space is viewed from a viewpoint of the avatar is displayed on a display viewed by the user,
the history information includes line-of-sight information indicating a direction of a line of sight of the avatar, and
the operations comprise performing at least one of generating the first estimation information by further using the line-of-sight information, and generating the second estimation information by further using the line-of-sight information.
